(19) United States
(12) Patent Application Publication
(10) Pub. No.: US 2009/0101230 A1
(43) Pub. Date: Apr. 23, 2009

(54) APPARATUS FOR FILLING AN OIL TANK

(76) Inventors: Duane H. Anstead, Fairfield, OH (US); Mark E. Zentgraf, Cincinnati, OH (US); Daniel Clautice, Mason, OH (US); Charles R. Granitz, Loveland, OH (US); Joshua D. Smith, Cincinnati, OH (US); Mark Hopper, West Chester, OH (US)

Correspondence Address: GENERAL ELECTRIC COMPANY, GE AVIATION, ONE NEUMANN WAY MD H17, CINCINNATI, OH, 45215, US

(21) Appl. No.: 11/875,228

(22) Filed: Oct. 19, 2007

(51) Int. Cl. B65B 3/04; B65D 47/00; F16K 24/00

(52) U.S. Cl. 141/326; 137/587; 220/86.1

(57) ABSTRACT

An apparatus for filling an oil tank may include one or more valves that may be arranged and/or sized in such a way as to assist in venting the oil tank during a fill operation and assure that the tank may be filled within a reasonable time.

### BACKGROUND OF THE INVENTION

The exemplary embodiments relate generally to gas turbine engines and more specifically to apparatus for venting oil tanks during filling while maintaining proper pressures in the oil tank during operation.

Gas turbine engine oil systems are typically pressurized upstream of the main oil supply pump to be sure that oil can be delivered in all operating conditions. Pressurizing the oil tank and maintaining the appropriate pressure may ensure that pumps downstream of the tank continue to provide oil to the engine. However, pressurization of the tank is not needed during filling and the tank must be vented as oil is added. There are two methods that may be used to fill an oil tank, pressure fill and gravity fill. Pressure filling involves pumping oil through an inlet fitting on the oil tank until it flows through an outlet. Gravity filling involves pouring oil into the tank until it is full.

As shown in FIG. 1, a typical oil tank 100 includes a reservoir 102 and a fill cap assembly 104 having a fill cap 106 and a valve 108. The oil tank 100 also includes a pressurization valve 110, a bleed orifice 112 and a dipstick 114. In some systems, a sight glass or overflow system may have been used in place of the dipstick 114 to measure the oil level within the tank 100. The pressurization valve 110 ensures that the tank 100 is held at a substantially constant pressure above the vented sink pressure. Typically, it is located at the top of the tank 100. After the engine shuts down, the pressure in the tank is bled off through the bleed orifice 112. The bleed orifice 112 is typically small so as to not impede the function of the pressurization valve 110 while allowing the bleed off to occur.

During normal operation, the fill cap 106 maintains the pressure and keeps the oil tank 100 from leaking. Should the fill cap 106 not be assembled, the tank 100 needs to remain pressurized and sealed. This may typically be accomplished through the use of a valve, such as valve 108. The pressure of the tank 100 will close the valve 108 so that, should the cap 106 be left off after filling or the cap assembly 104 not assembled correctly, the tank 100 will not leak and the pressure will be maintained normally.

FIGS. 2-5 show a typical oil tank 100 in different stages of operation. The fill cap 106 is shown in phantom as having been left off or removed. FIG. 2 illustrates the oil tank 100 during normal operation. The pressurization valve 110 maintains the pressure in the tank 100 while the pressure holds the valve 108 closed. FIG. 3 illustrates the tank 100 while it is being filled. The oil head (i.e. the pressure of the incoming oil) pushes the valve 108 open to allow the oil into the tank 100 and displaced air is vented out of the tank 100 back through the fill cap 106. FIG. 4 shows the tank 100 when the oil level is above the valve 108. During this stage of the filling process, the air is venting through the bleed orifice 112. In FIG. 5, the tank 100 is full. As gas turbine engine technology advances, in order to ensure proper pressure at the pump inlet, the bleed orifice size may need to be constrained. This may not allow the bleed orifice to be sized large enough to allow proper venting during filling once the oil level is above the valve 108. This may lead to inappropriately slow fill rates and longer service visits.

### BRIEF DESCRIPTION OF THE INVENTION

The exemplary embodiments described herein attempt to solve or mitigate these problems by providing apparatus for venting the tank during filling and shutdown while maintaining proper pressures during operation. In one exemplary embodiment, a fill cap assembly for an oil tank having a full fill level may include a first valve at least partially above the full fill level for venting air from said oil tank during a fill operation and a second valve normally biased towards an open position. In another exemplary embodiment, an oil tank may include a reservoir, a bleed orifice associated with the reservoir and being sized so as to vent the reservoir during a fill operation. The oil tank may also include a valve disposed within the bleed orifice for restricting the bleed orifice during normal operation. In yet another exemplary embodiment, an oil tank having a full fill level may include a reservoir and a fill cap assembly associated with the reservoir. The fill cap assembly may have a buoyant valve disposed at least partially above said full fill level for venting the oil tank during a fill operation.

### BRIEF DESCRIPTION OF THE DRAWINGS

FIG. 1 is a cross sectional schematic view of a known oil tank.

FIG. 2 is a cross sectional schematic view of a known oil tank during normal operation.

FIG. 3 is a cross sectional schematic view of a known oil tank while being filled.

FIG. 4 is a cross sectional schematic view of a known oil tank when the oil is at a particular level.

FIG. 5 is a cross sectional schematic view of a known oil tank when full.

FIG. 6 is a cross sectional schematic view of one exemplary embodiment of an oil tank.

FIG. 7 is a cross sectional schematic view of another exemplary embodiment of an oil tank shown during operation with the fill cap removed.

FIG. 8 is a cross sectional schematic view of the exemplary embodiment of FIG. 7 shown during filling.

FIG. 9 is a cross sectional schematic view of an exemplary embodiment of a fill cap assembly.

FIG. 10 is a cross sectional schematic view of another exemplary embodiment of a fill cap assembly.

FIG. 11 is an enlarged cross sectional schematic view of an exemplary embodiment of a bleed orifice for an oil tank during normal operation.

FIG. 12 is an enlarged cross sectional schematic view of the exemplary embodiment of a bleed orifice of FIG. 11 during filling.

FIG. 13 is an enlarged cross sectional schematic view of an exemplary embodiment of a bleed orifice for an oil tank during normal operation.

FIG. 14 is an enlarged cross sectional schematic view of the exemplary embodiment of a bleed orifice of FIG. 13 during filling.

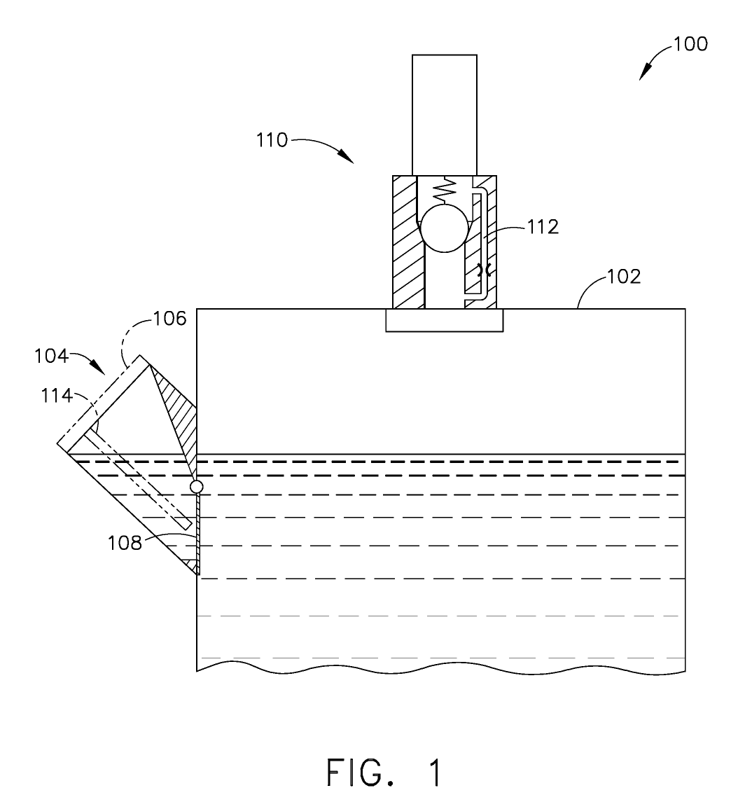

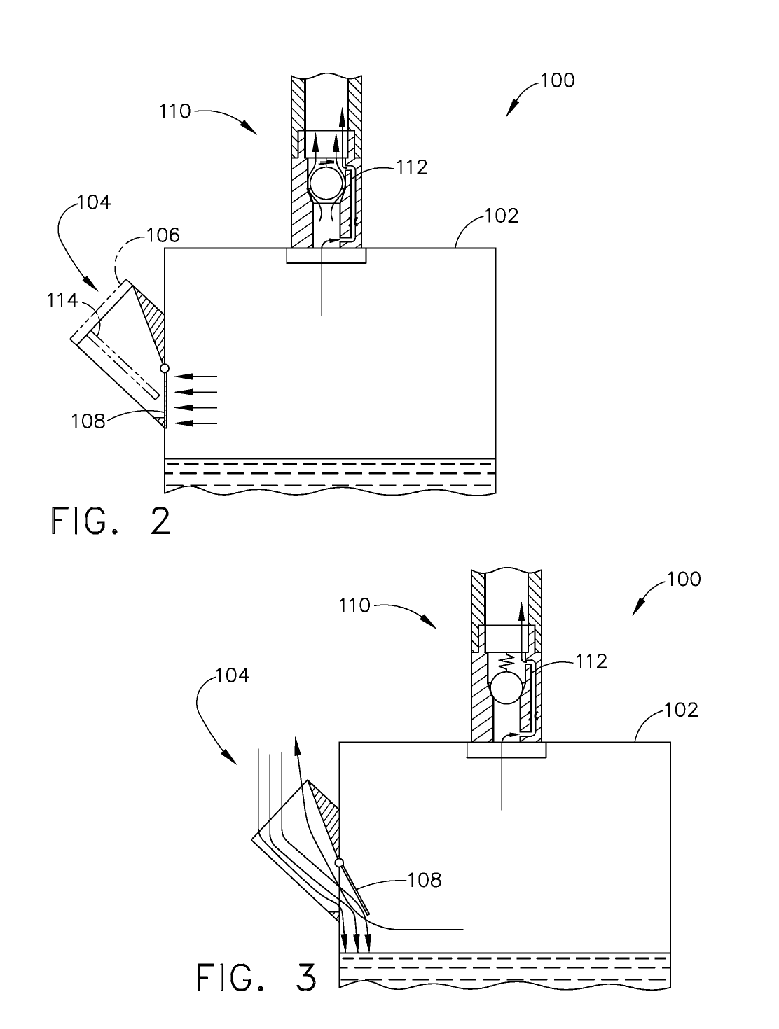

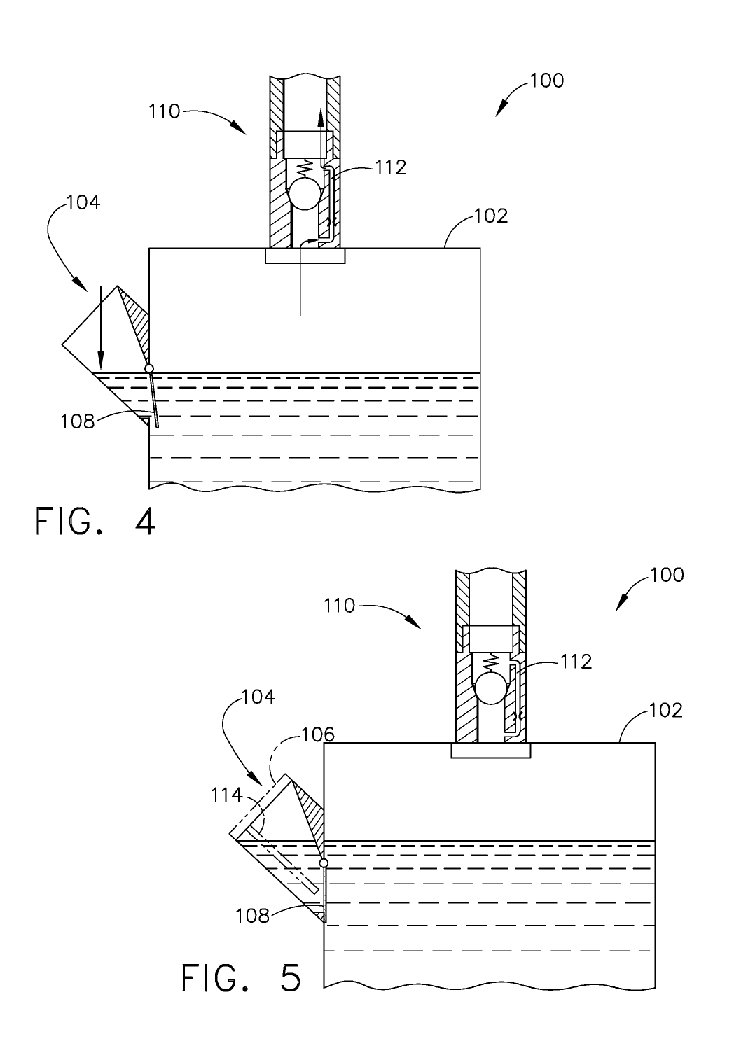

### DETAILED DESCRIPTION OF THE INVENTION

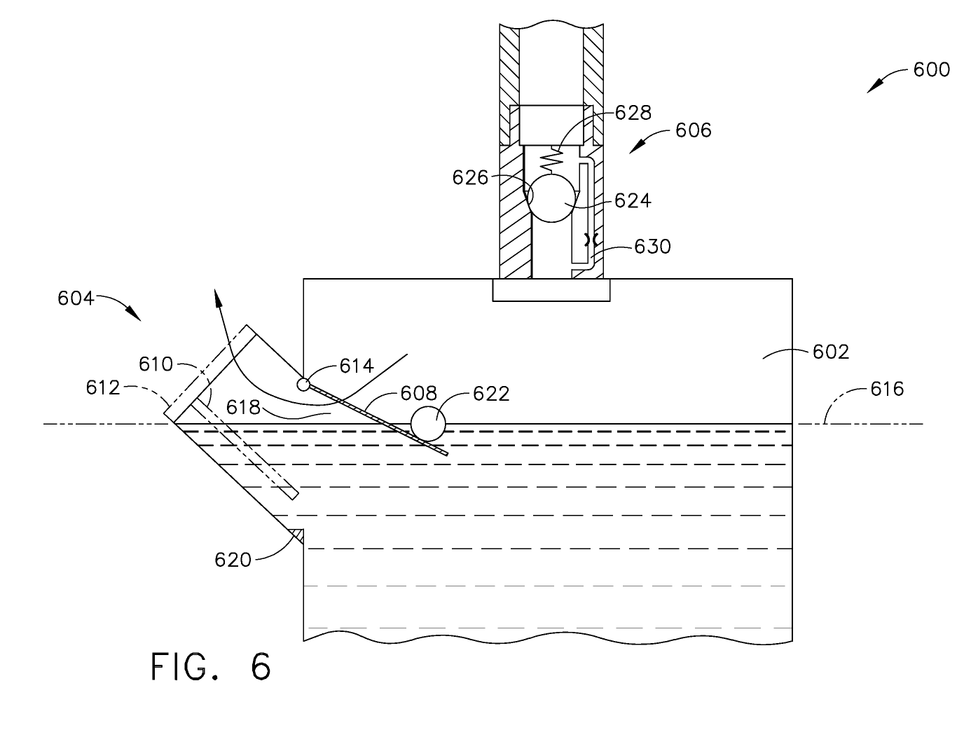

FIG. 6 illustrates a cross sectional schematic view of one exemplary embodiment of an oil tank. The oil tank 600 may include a reservoir 602, a fill cap assembly 604 and a pressurization valve 606. The fill cap assembly 604 may include a valve 608, a dipstick 610 and a fill cap 612. As should be understood by one of ordinary skill in the art, any valves described herein may be any valve type known in the art, such as, but not limited to, flapper valves, ball valves and poppet valves. It should also be understood by one of ordinary skill in the art, that the valves may normally be biased in an open or closed position such that a certain force needs to be overcome in order to switch the valve from an open to a closed position or from a closed position to an open position. The valve 608 may be connected to the fill cap assembly 604 through a connector 614. In this particular exemplary embodiment, the valve 608 is a flapper valve and the connector 614 is a hinge, however, any valve and connector arrangement may be used. The valve 608 may be disposed such that the connector 614 is positioned above the full fill level 616 of the reservoir 602. This may allow air to flow out of the reservoir 602 through gap 618 during filling. Should the cap 612 be left off after filling or the fill cap assembly 604 not assembled correctly, the valve 608 may rest against the seat 620 during normal operation to seal the reservoir 602 and fill cap assembly 604.

The valve 608 may be made to be buoyant to reduce the amount of force needed to open the valve during filling. The buoyancy may be accomplished in a number of ways. For example, the valve 608 may be made of buoyant materials or made of a hollow construction. Further examples may include, but are not limited to, attaching a float, such as float 622 or placing cutouts in the bottom of the valve to capture an air bubble. The pressurization valve 606 may include a ball valve 624, a ball seat 626, a spring 628 and a bleed orifice 630. The dipstick 610 may be used to determine the oil level in the tank 600. As should be known by one of ordinary skill in the art, a sight glass, overflow system, and/or other similar devices for determining the oil level within the tank 600 may be used in place of the dipstick 610.

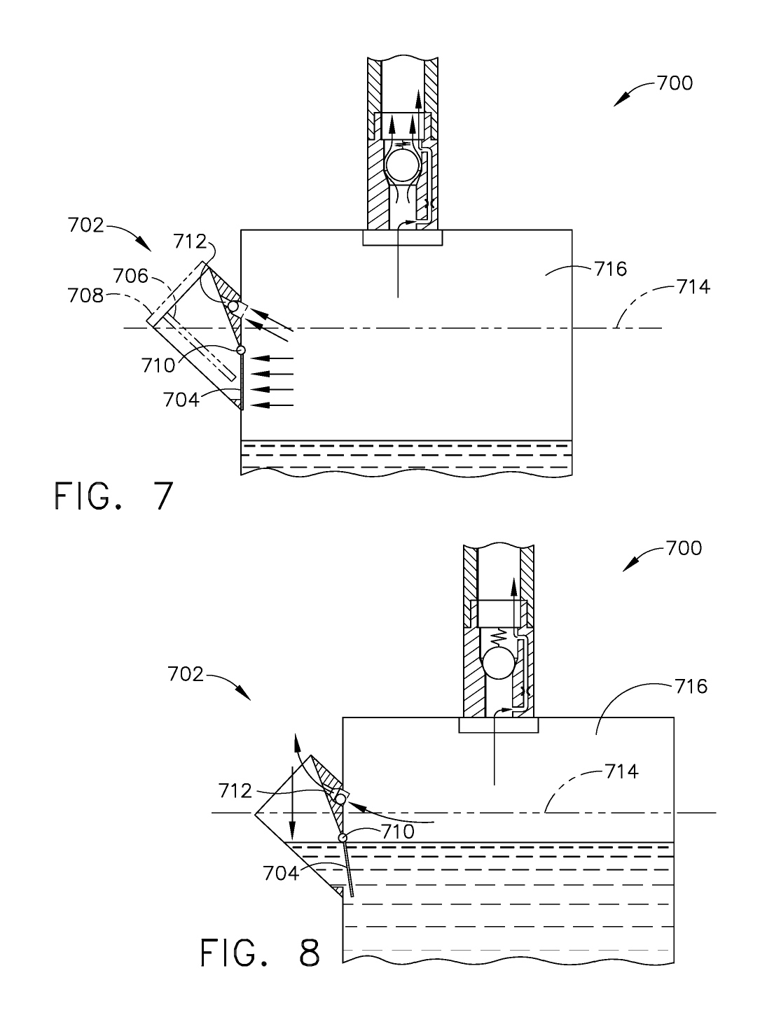

FIGS. 7 and 8 show a cross sectional schematic view of another exemplary embodiment of an oil tank. FIG. 7 shows the oil tank during normal operation. FIG. 8 shows the oil tank during filling. The exemplary embodiment illustrated in FIGS. 7-8 is similar to the exemplary embodiment shown in FIG. 6 except for the fill cap assembly. As shown in FIGS. 7-8, oil tank 700 may have a fill cap assembly 702 which may include a valve 704, a dipstick 706 and a fill cap 708. The valve 704 may be connected to the fill cap assembly 702 through a connector 710 and may normally be biased towards a closed position. In this particular exemplary embodiment, the valve 704 is a flapper valve and the connector 710 is a hinge, however, any hinge and connector arrangement may be used. The fill cap assembly 702 may have a valve 712 disposed above the full fill level 714. Valve 712 may be biased towards an open position. Should the cap 708 be left off after filling or the cap assembly 702 not assembled correctly, the valve 712 would be closed during normal operation due to the pressure inside the reservoir 716 overcoming the bias associated in keeping the valve open. In one exemplary embodiment, this bias may be gravity. During filling procedures, the valve 712 would be open, as shown in FIG. 8, so as to allow air to vent outside the oil tank 700 once the oil level is above the connector 710. As shown in FIGS. 7-8, the valve 712 may be a ball valve.

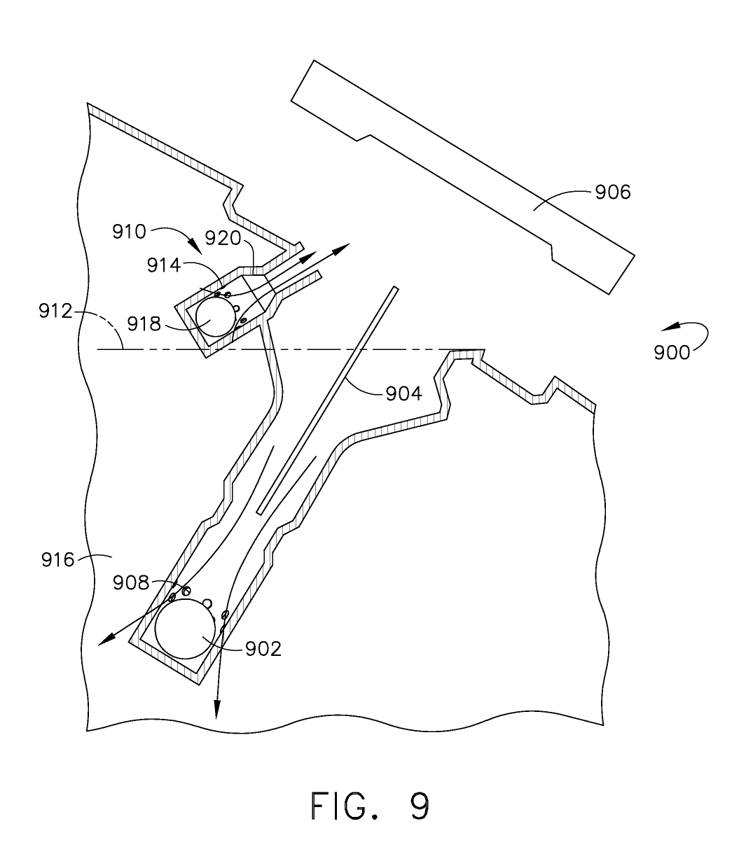

FIG. 9 is a cross sectional schematic view of an exemplary embodiment of a fill cap assembly. The fill cap assembly 900 may have a valve 902, a dipstick 904 and a fill cap 906. In this particular exemplary embodiment, the valve 902 is a ball valve that may have a plurality of holes 908. The valve 902 may normally be biased in an open position. The holes 908 may allow the oil to flow into the tank past the ball while also acting as a coarse screen. The fill cap assembly 900 may have a valve 910 disposed above the full fill level. The valve 910 may also be a ball valve having a plurality of holes 914. Should the fill cap be removed or not assembled, the valve 910 would be closed during normal operation due to pressure inside the reservoir 916 forcing the ball 918 to seal against the seat 920. During filling procedures, the valve 910 would be open, as shown in FIG. 9, to allow air to vent outside the fill cap assembly 900 through holes 914.

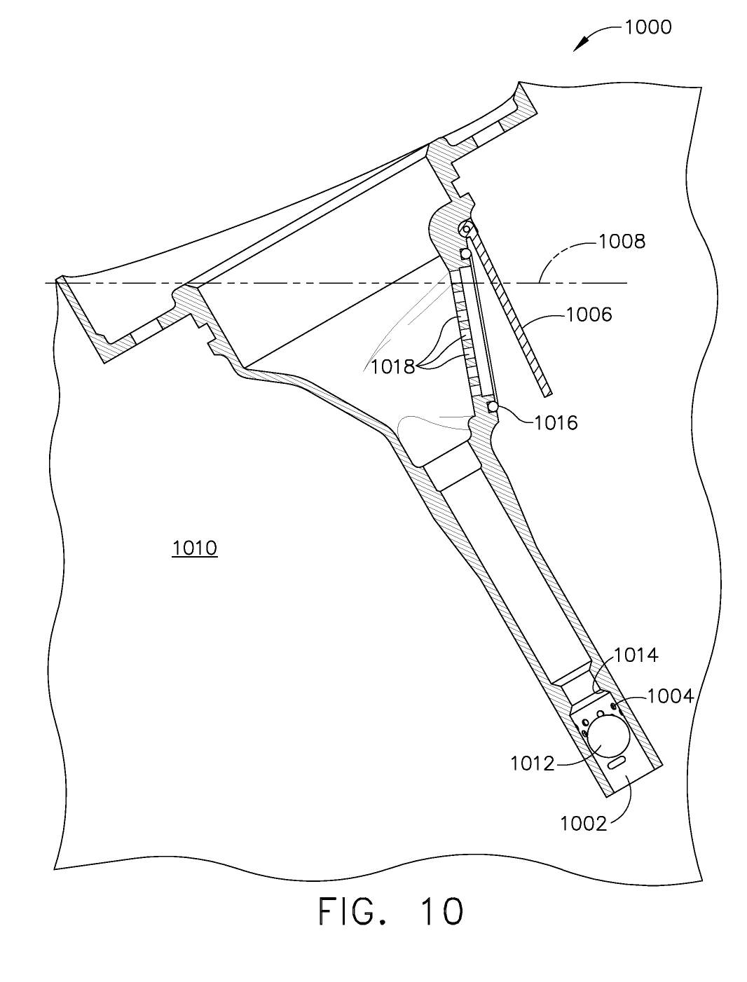

FIG. 10 is a cross sectional schematic view of another exemplary embodiment of a fill cap assembly. The fill cap assembly 1000 may have a valve 1002, a dipstick (not shown) and a fill cap (not shown). The valve 1002 may normally be biased towards an open position. In this particular exemplary embodiment, the valve 1002 is a ball valve that may have a plurality of holes 1004. The holes 1004 may allow the oil to flow into the tank past the ball while also acting as a coarse screen. The fill cap assembly 1000 may also have a valve 1006 disposed above the full fill level 1008 and normally biased towards a closed position. The valve 1006 may be a flapper valve and may also have a plurality of holes 1018 disposed therein for acting as a coarse screen. The flapper valve 1006 may be positioned so that oil may flow through it as well as valve 1002. Should the fill cap be removed or not assembled, the valves 1002 and 1006 would be closed during normal operation due to pressure inside the reservoir 1010 forcing the ball 1012 to seal against the seat 1014 and the flapper valve 1006 to seal against seat 1016. During filling procedures, the valve 1006 would be open, as shown in FIG. 10, to allow air to vent outside the fill cap assembly 1000 through valve 1006.

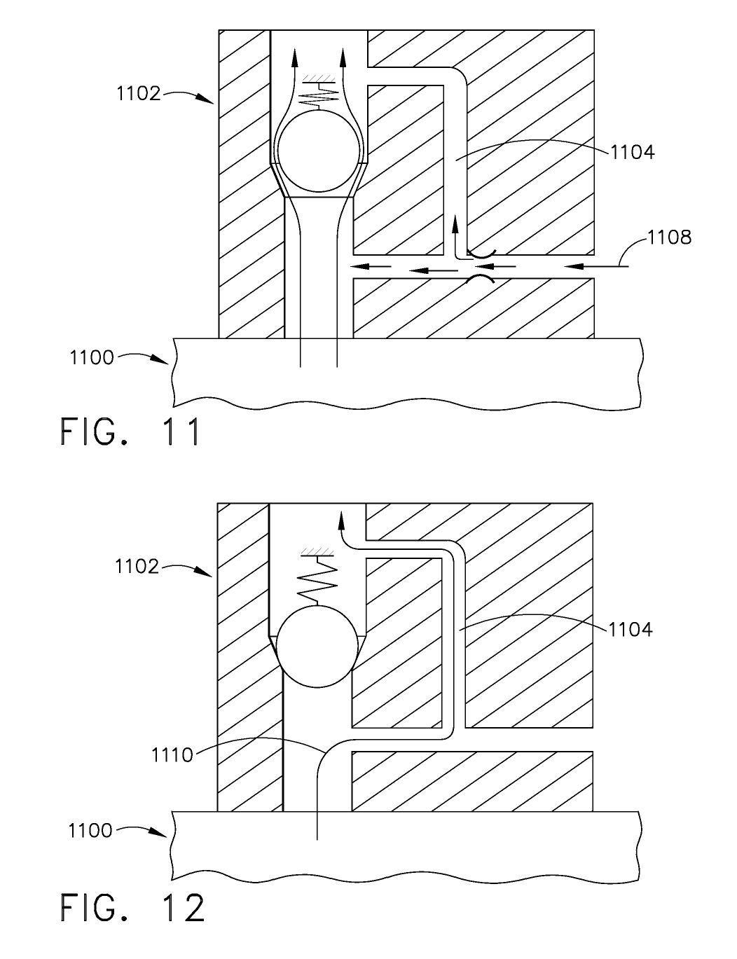

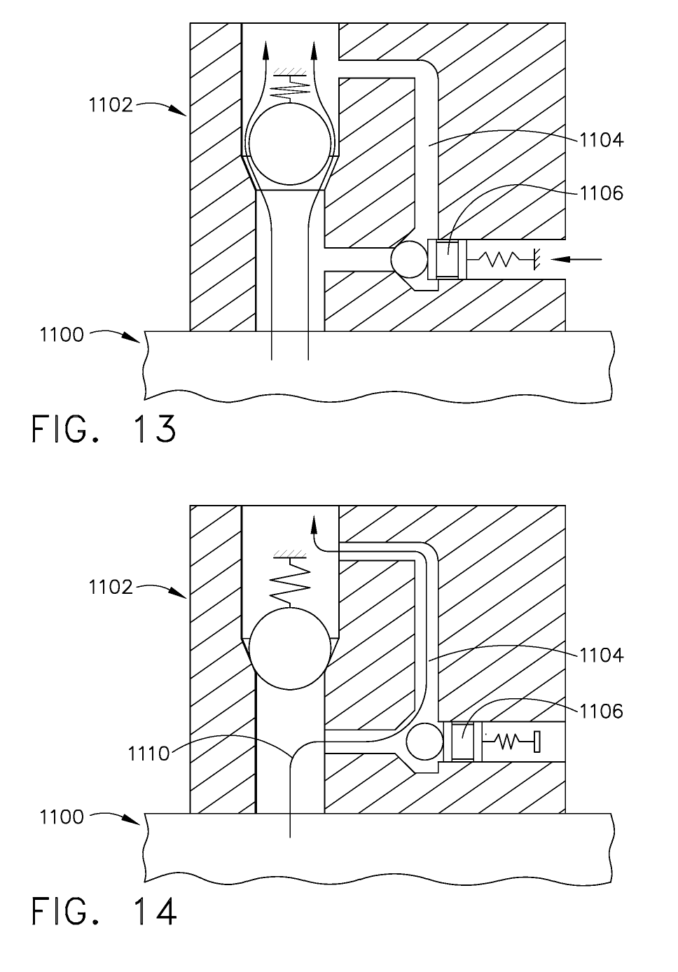

FIGS. 11-14 illustrate another exemplary embodiment of an oil tank. As shown in FIGS. 11-14, the oil tank 1100 may include a pressurization valve 1102 and a bleed orifice 1104. The bleed orifice 1104 may be sized so that air may be vented through it during filling. In order to sufficiently maintain the pressure within the tank during normal operation, the bleed orifice 1104 may need to be closed or restricted. One exemplary embodiment for accomplishing this restriction is shown in FIGS. 11 and 12. Oil 1108 may flow through the bleed orifice 1104 from an external source, thus restricting airflow through the bleed orifice 1104. The oil 1108 may act as a valve within the bleed orifice 1104 so that during normal operation the bleed orifice 1104 is closed or restricted and during a fill operation the bleed orifice 1104 is opened or unrestricted allowing air 1110 to vent through the bleed orifice 1104. Another exemplary embodiment of the restriction is illustrated in FIGS. 13 and 14. A valve 1106 may be placed in the bleed orifice 1104. During filling, the valve 1106 may be open allowing air 1110 to freely pass through the bleed orifice 1104. During operation, the valve 1106 may be actuated to close the bleed orifice 1104. The valve 1106 may be actuated in a number of ways, including, but not limited to, air pressure, fuel pressure, oil pressure or electronically.

Through the use of the exemplary embodiments described herein, appropriate venting may be maintained during the entire filling operation, while allowing normal pressurization of the tank during normal operation of the engine. This may allow the oil tank to be filled in a reasonable time and assure that pressure will be maintained within the tank during normal operation of the engine. The exemplary embodiments described herein also assure that, should the fill cap be left off after filling or the fill cap assembly not assembled correctly, the tank will not leak and the pressure will be maintained normally.

While the exemplary embodiments described and claimed herein have been directed to oil, it should be understood by one of ordinary skill in the art that the exemplary embodiments could apply to any fluid, such as but not limited to, hydraulic fluid, water, coolant, fuel, etc. Similarly, the oil tank is not limited to a container for oil but could be any container for storing the fluids listed above.

This written description discloses exemplary embodiments, including the best mode, to enable any person skilled in the art to make and use the exemplary embodiments. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fill cap assembly for an oil tank having a full fill level, comprising:
a first valve at least partially above said full fill level for venting air from said oil tank during a fill operation;
a second valve normally biased towards an open position.

2. The fill cap assembly of claim 1 wherein said first valve is normally biased towards a closed position.

3. The fill cap assembly of claim 1 wherein said first valve is normally biased towards an open position.

4. The fill cap assembly of claim 3 wherein said first valve is disposed above said full fill level.

5. The fill cap assembly of claim 1 wherein said second valve includes a plurality of holes for allowing oil to pass therethrough.

6. The fill cap assembly of claim 5 wherein said second valve is disposed below said full fill level.

7. The fill cap assembly of claim 1 wherein said first valve includes a plurality of holes for allowing oil to pass therethrough.

8. The fill cap assembly of claim 1 further comprising a fill cap and a dipstick associated with said fill cap.

9. An oil tank, comprising:
a reservoir;
a bleed orifice associated with said reservoir, said bleed orifice being sized so as to vent said reservoir during a fill operation; and
a valve disposed within said bleed orifice for restricting said bleed orifice during normal operation.

10. The oil tank of claim 9 further comprising a pressurization valve, wherein said bleed orifice is disposed within said pressurization valve.

11. The oil tank of claim 9 further comprising a fill cap assembly associated with said reservoir.

12. The oil tank of claim 9 wherein said valve is oil flowing through the bleed orifice from an external source.

13. The oil tank of claim 9 wherein said valve is an actuated valve.

14. An oil tank having a full fill level, comprising:
a reservoir;
a fill cap assembly associated with said reservoir, said fill cap assembly comprising a buoyant valve disposed at least partially above said full fill level for venting said oil tank during a fill operation.

15. The oil tank of claim 14 wherein said valve includes a float.

16. The oil tank of claim 14 wherein said valve is a buoyant flapper valve.

17. The oil tank of claim 14 further comprising a fill cap associated with said fill cap assembly and a dipstick associated with said fill cap.

18. The oil tank of claim 14 further comprising a pressurization valve associated with said reservoir.

19. The oil tank of claim 18 further comprising a bleed orifice disposed within said pressurization valve.

20. The oil tank of claim 19 further comprising a bleed orifice associated with said reservoir.
